(19) United States
(12) Patent Application Publication
(10) Pub. No.: US 2025/0346368 A1
(43) Pub. Date: Nov. 13, 2025

(54) LINEAR ACTUATING DEVICE AND ASSOCIATED AIRCRAFT ROTOR TEST BENCH

(71) Applicant: AIRBUS HELICOPTERS, Marignane Cedex (FR)

(72) Inventors: Fabien VARGAS, Aix En Provence (FR); Laurent JAUFFRET, Velaux (FR)

(73) Assignee: AIRBUS HELICOPTERS, Marignane Cedex (FR)

(21) Appl. No.: 19/081,190

(22) Filed: Mar. 17, 2025

(30) Foreign Application Priority Data
May 7, 2024 (FR) FR2404795

(51) Int. Cl. B64F 5/60; B64C 27/64; F15B 15/14

(52) U.S. Cl. CPC B64F 5/60; B64C 27/64; F15B 15/1409

(57) ABSTRACT

A linear actuating device comprising a main actuator provided with a main body and with a main rod able to move with at least one degree of freedom in translation with respect to the main body. According to the disclosure, the linear actuating device comprises an emergency system configured, in a nominal operating mode of the linear actuating device, to allow the main rod to move with respect to the main body and, in an emergency operating mode of the linear actuating device, to return and then maintain the main rod in a predetermined refuge position.

### CROSS REFERENCE TO RELATED APPLICATION

This application claims priority to French patent application No. FR 24 04795 filed on May 7, 2024, the disclosure of which is incorporated in its entirety by reference herein.

### TECHNICAL FIELD

The present disclosure relates to the technical field of linear actuation devices. Such devices may comprise, for example, actuators or cylinders with hydraulic, pneumatic or electrical control, and at least two elements that can move in translation with respect to each other, such as a body and a rod.

### BACKGROUND

For example, a rotor test bench may comprise a plurality of linear actuators for moving a set of swashplates of the tested rotor.

However, a linear actuating device may be subjected during its use to different failure cases that may cause a malfunction, or even to a failure preventing the translational movement of a moving element from being controlled.

In addition, for some applications, such as on an aircraft rotor test bench where multiple linear actuating devices may be used, such a failure of a linear actuating device may be problematic and result in severe damage to the test bench and/or to the system under test.

Furthermore, it should be noted that documents CN104973238, U.S. Pat. No. 10,683,880, US20150152842, CN108953280 and CN111188850 disclose linear actuating devices that are far from the disclosure.

### SUMMARY

An object of the present disclosure is therefore to provide a device that can improve the safety level of a linear actuating device.

The disclosure therefore relates to a linear actuating device comprising a main actuator provided with a main body and with a main rod able to move with at least one degree of freedom in translation with respect to said main body.

Such a linear actuation device comprises an emergency system configured:
in a nominal operating mode of the linear actuating device, to allow movement of the main rod of the main actuator with respect to the main body; and
in an emergency operating mode of the linear actuating device, to return and then maintain the main rod of the main actuator in a predetermined refuge position.

In other words, such a safety system is able to leave the main rod of the main actuator free to move as long as the linear actuating device is in its nominal operating mode.

On the other hand, in the event of a failure of the main actuator or of a control system of this main actuator, the emergency system is activated to prevent the main rod from moving freely with respect to the main body. Depending on the current position of the main rod, during the implementation of the emergency operating mode, the emergency system can then move the main rod to place it and maintain it in the predetermined refuge position with respect to the main body. The emergency system then prohibits any movement of the main rod with respect to the main body.

In addition, such a main rod may be said to be a “through rod” or a “non-through rod” inside the main body. In the case of a through rod, a piston head secured to the main rod and separating two pressurized chambers is arranged between two rod portions. Alternatively, in the case of a non-through rod, a piston head secured to the main rod is arranged at a free end of the main rod.

Moreover, such a main rod can form either a monolithic assembly, or have at least two portions secured to each other, or have at least two portions that can move with respect to one another. In the latter case, the main rod may, for example, comprise a first section and a second section that are able to move at least in translation with respect to one another along a main translation axis along which the main rod moves with respect to the main body.

When such a linear actuating device is used on a rotor test bench, it is then able, in the event of malfunction of the main actuator or of the control of this main actuator, to control the pitch of the blades of this rotor to a predetermined pitch corresponding to the predetermined refuge position of the main rod of the main actuator.

For example, in this emergency operating mode of the linear actuating device, the predetermined pitch of the blades may correspond to a zero pitch so as not to transmit any vertical thrust to a chassis of the test bench.

Furthermore, the switching from the nominal operating mode to the emergency operating mode of the linear actuating device may be performed automatically by the linear actuating device, using at least one sensor configured to detect a failure or malfunction of the main actuator or of its control system. A controller is then in communication with the one or more sensors and applies instructions to determine the presence of a malfunction and consequently to control the emergency system.

Alternatively or additionally, such a switching from the nominal operating mode to the emergency operating mode of the linear actuating device may be effected by an operator monitoring the operation of the linear actuating device. Such an operator thus actuates a human-machine interface, such as a button, an emergency switch or a touch panel, making it possible both to deactivate the nominal operating mode of the linear actuating device and to activate the emergency operating mode of the linear actuating device.

In addition, the main actuator may be controlled by means of a hydraulic, pneumatic or even electrical control. For example, the main actuator may include a hydraulic cylinder connected to a hydraulic fluid supply system, the supply system comprising at least one hydraulic pump hydraulically connected to the main actuator by hoses.

The use of a hydraulic cylinder and a hydraulic fluid makes it possible, in particular, to quickly transmit the energy and pressure provided by a pump in order to move the main rod. Moreover, because it is a viscous fluid, the hydraulic fluid can also lubricate various components, such as the hydraulic pump, the distributors and the cylinder. In addition, one or more pressure accumulators may be used to store pressurized hydraulic fluid before being dispensed to the main actuator.

Moreover, the emergency system comprises a secondary actuator provided with a secondary body and a secondary rod that can move with one degree of freedom in translation with respect to the secondary body, the secondary rod being secured to the main rod only in the emergency operating mode of the linear actuating device.

Thus, such a secondary actuator may, for example, be arranged mechanically in parallel with the main actuator. The main rod has a degree of freedom in translation along a main translation axis and the secondary rod has a degree of freedom in translation along a secondary translation axis parallel to the main translation axis.

In the nominal operating mode of the linear actuating device, the secondary rod remains immobile in a predetermined rest position, for example central, with respect to the secondary body.

On the other hand, in the emergency operating mode of the linear actuating device, the secondary rod can be moved from the predetermined rest position, together with the main rod, to place and maintain the main rod in its predetermined refuge position.

In another aspect, such a secondary actuator may be controlled by means of a hydraulic, pneumatic or even electric control. For example, the secondary actuator may include an electric motor able to rotate an endless screw cooperating with a nut or a ball mechanism capable of converting the rotational movement of the screw into a translational movement of the secondary rod.

In accordance with the disclosure, the emergency system includes a hydraulic blocker secured to the secondary rod, the hydraulic blocker comprising a deformable clamping ring configured:
in the nominal operating mode, to enable frictionless sliding of the main rod with respect to the clamping ring; and
in the emergency operating mode, to exert a pressing force on the main rod and secure together the main rod and the secondary rod in translation.

In other words, such a blocker can be connected to a hydraulic actuator making it possible to control a state of the deformable clamping ring. Such a clamping ring may in particular have an internal cylindrical surface of revolution cooperating with an external cylindrical surface of revolution of the main rod.

In a nominal state of the deformable clamping ring implemented during the nominal operating mode, the internal cylindrical surface of revolution has a functional clearance with the external cylindrical surface of revolution. Such a functional clearance is then capable of enabling relative translational guidance between the main rod and the blocker, and therefore with the secondary rod.

In a clamped state of the deformable clamping ring implemented during the emergency operating mode, the internal cylindrical surface of revolution has a press-fit with the external cylindrical surface of revolution.

In addition, the high deformation capacity of the clamping ring may be obtained by means of a plurality of notches arranged, for example, axially in the thickness of the clamping ring. Two successive notches may furthermore open onto two opposite flat faces delimiting an external volume of the clamping ring. Each notch may then have an open end cooperating with an external planar face of the clamping ring and a non-open end cooperating with an internal cylindrical face of a radial bore of the clamping ring.

Furthermore, the coefficient of friction between the clamping ring and the main rod can be improved by depositing a material. A thin layer of material intended to increase the coefficient of friction can thus be added at least locally at the internal cylindrical surface of revolution.

Advantageously, the emergency system may comprise adjustment means configured to axially adjust a relative position between the secondary body and the main body, as well as reversible securing means configured to secure the secondary body to the main body.

Such adjustment means make it possible to adapt the emergency system as a function of a particular use of the linear actuating device and in particular to arrange the secondary rod in its predetermined rest position as a function of a particular total travel of the main rod with respect to the main body.

Thus, it is possible to use a same linear actuating device that is compatible with various models of rotors and therefore to limit the design and manufacturing costs of the linear actuating devices fitted to a test bench.

In practice, the hydraulic blocker may comprise:
a housing;
a plurality of pistons radially arranged in the housing with respect to a main translation axis of movement of the main rod, the pistons sliding respectively in chambers hydraulically connected in parallel to a hydraulic supply comprising a pump configured to compress a fluid in the chambers, the fluid enabling a thrust force to be exerted on each piston in order to place each piston in a first end position corresponding to the nominal operating mode; and
elastic return means each exerting a return force on a piston in order to move each piston from the first end position to a second end position corresponding to the emergency operating mode.

In other words, the hydraulic supply makes it possible to position and maintain the pistons in their first end position inside the housing, in order to allow the deformable clamping ring to be arranged in its nominal state.

In addition to a pump, such a hydraulic supply may include other hydraulic elements such as hoses and one or more pressure accumulators.

Advantageously, the emergency system may comprise a tracking system configured to generate tracking information as a function of a current position of the main rod with respect to the main body relative to the refuge position.

Thus, such a tracking system is able, at any time, to track the current position of the main rod and to know, when the emergency operating mode is implemented, in which direction the main rod must be moved to move closer to its refuge position and to position itself there.

According to an exemplary embodiment of the disclosure, the tracking system may comprise a sleeve that can move with one degree of freedom in translation with respect to a support along a tracking translation axis, the sleeve being secured with the main rod and configured to move in translation jointly with the main rod, the tracking translation axis being parallel to the main translation axis.

In other words, a connecting arm makes it possible to secure together the main rod and the sheath, for example at their respective: free ends. Such a connecting arm may extend perpendicularly with respect to the main translation axis.

In practice, the sleeve may comprise an outer cylindrical surface provided with three tracks, oriented parallel with the tracking translation axis, the three tracks being respectively offset in azimuth with respect to each other about the tracking translation axis.

Each track may thus extend longitudinally along the tracking translation axis. The tracks may, for example, be arranged next to one another on the outer cylindrical surface of the sheath or be angularly offset by 120° with respect to one another.

Advantageously, the tracking system comprises three sensors, secured to the support, each track being arranged opposite a sensor and having at least two colored portions having at least two different colors intended to be identified by the sensor.

Each sensor may be of the logic or on/off type, in other words providing a change of state digitally with a value of 0 or 1. For example, each sensor can detect a colored portion of a track and the sensors can jointly determine the current relative position of the sheath with respect to the refuge position using a truth table in Boolean algebra. For example, the refuge position may be defined by the simultaneous identification on the three tracks of a combination of three colored portions having an identical first color.

A first track may thus have two colored portions of different colors arranged one after the other in a direction parallel to the tracking translation axis. For example, a first colored portion arranged in an upper portion of the sheath has the first color, and a second colored portion arranged in a lower portion of the sheath has a second color.

Said first track is able to indicate a first movement direction of the main rod with respect to its refuge position. According to the preceding example, this first movement direction may thus correspond to an axis oriented from the lower part of the sheath towards the upper part of the sheath.

A second track may have two colored portions of different colors arranged one after the other in a direction parallel to the tracking translation axis, the arrangement of the two colored portions of the second track being reversed with respect to that of the first track. For example, a first colored portion arranged in the lower part of the sheath has the first color, and a second colored portion arranged in the upper part of the sheath has the second color. The refuge position can then be identified at a very localized azimuth overlap of the first colored portions of the first and second tracks.

This second track may indicate a second movement direction, opposite to the first movement direction, of the main rod with respect to its refuge position. This second movement direction can thus correspond to an axis oriented from the upper part of the sheath towards the lower part of the sheath.

In addition, the main rod may be arranged in its refuge position when both a first sensor detects the first color on the first track and a second sensor detects the first color on the second track.

Finally, a third track may have three colored portions with two different colors arranged one after the other in a direction parallel to the tracking translation axis.

For example, a first colored portion arranged in a central portion of the sheath has the first color, a second colored portion arranged in the upper portion of the sheath has the second color, and a third colored portion arranged in the lower portion of the sheath has the second color. The second and third colored portions, when detected by a third sensor, are then able to identify that an end-of-travel stop of the main rod has been reached.

In conjunction with detection of the second colored portions of the first and second tracks, the truth table identifies whether it is an upper or a lower end-of-travel stop. Indeed, when the second colored portion of the first track is detected simultaneously with the second colored portion of the third track, an upper stop can be identified and when the second colored portion of the second track is simultaneously detected with the third colored portion of the third track, a lower stop can be identified.

According to another exemplary embodiment of the disclosure, the emergency system comprising a secondary actuator provided with a secondary body and with a secondary rod able to move with one degree of freedom in translation with respect to the secondary body, the tracking system can comprise a controller connected to the three sensors in order to generate the tracking information as a function of the current relative position of the main rod with respect to the refuge position and to control the secondary actuator to move the main rod into the refuge position.

Thus, such a controller of the tracking system is connected by wired or wireless means to the three sensors and is able to constantly know the relative position of the main rod with regard to its refuge position. The controller can also identify from the truth table in Boolean algebra, whether the main rod has reached one of its end-of-travel stops.

When the nominal operating mode is implemented, the controller can send a command to the main actuator to stop a movement of the main rod when it has reached one of the end-of-travel stops.

In addition, when the emergency operating mode is implemented, the controller can send a control command to the secondary actuator to return the main rod to the refuge position.

In practice, the linear actuating device may comprise at least one balancing counterweight offset radially with respect to a main translation axis of movement of the main rod.

The one or more balancing counterweights are further configured to counter an imbalance caused by the emergency system. Thus, as a function of the weight and position of the emergency system with respect to the main translation axis, the number and weights of the balancing counterweights may be modified. The one or more balancing counterweights then enable the center of gravity of a linear actuating device to be returned to the main translation axis.

Another object of the present disclosure is an aircraft rotor test bench, the rotor being provided with a hub and blades, the test bench comprising a motor that enables the rotor to be rotated.

According to the disclosure, such a test bench comprises at least one linear actuating device as described above, and, during a rotational movement of the rotor, said at least one linear actuating device is configured, in the nominal operating mode, to vary a pitch of the blades of the rotor with respect to the hub and, in the emergency operating mode, to maintain the pitch of the blades of the rotor at a predetermined value.

In practice, the test bench may comprise at least three linear actuating devices in accordance with the disclosure arranged in place of the servocontrols varying the pitch of the blades of the rotor when the latter is arranged on an aircraft. The three linear actuating devices may then be arranged, for example, equidistributed about the axis of rotation of the rotor.

A first end of each linear actuating device is arranged in a ball-joint or pivot connection with a chassis of the test bench and can thus have at least one degree of freedom in rotation with respect to this chassis.

Similarly, a second end of each linear actuating device is arranged in ball-joint or pivot connection with a system of plates for controlling the pitch of the blades of the rotor and can thus have at least one degree of freedom in rotation with respect to this system of plates for controlling the pitch of the blades of the rotor.

Such a test bench is thus safe and can limit the level of risk of accident in the event of malfunctioning of a main actuator during use of the test bench and during rotation of a rotor at high rotation speeds.

### BRIEF DESCRIPTION OF THE DRAWINGS

The disclosure and its advantages appear in greater detail from the following description of examples given by way of illustration with reference to the accompanying figures, wherein:

FIG. 1 is a perspective view of a test bench according to the disclosure;

FIG. 2 is a perspective view of a linear actuating device according to the disclosure;

FIG. 3 is a perspective view of a secondary actuator of the linear actuating device according to the disclosure;

FIG. 4 is a perspective view of a hydraulic blocker of the linear actuating device according to the disclosure;

FIG. 5 is a sectional perspective view of the hydraulic blocker of the linear actuating device according to the disclosure;

FIG. 6 is a sectional view of the hydraulic blocker of the linear actuating device according to the disclosure;

FIG. 7 is a partial perspective view of the hydraulic blocker of the linear actuating device according to the disclosure;

FIG. 8 is a sectional perspective view of a hydraulic blocker piston of the linear actuating device according to the disclosure;

FIG. 9 is a perspective view of a tracking system of the linear actuating device according to the disclosure;

FIG. 10 is a perspective view of a sheath of the tracking system of the linear actuating device according to the disclosure; and

FIG. 11 is a perspective view of the monitoring system of the linear actuating device according to the disclosure.

### DETAILED DESCRIPTION

Elements present in more than one of the figures are given the same references in each of them.

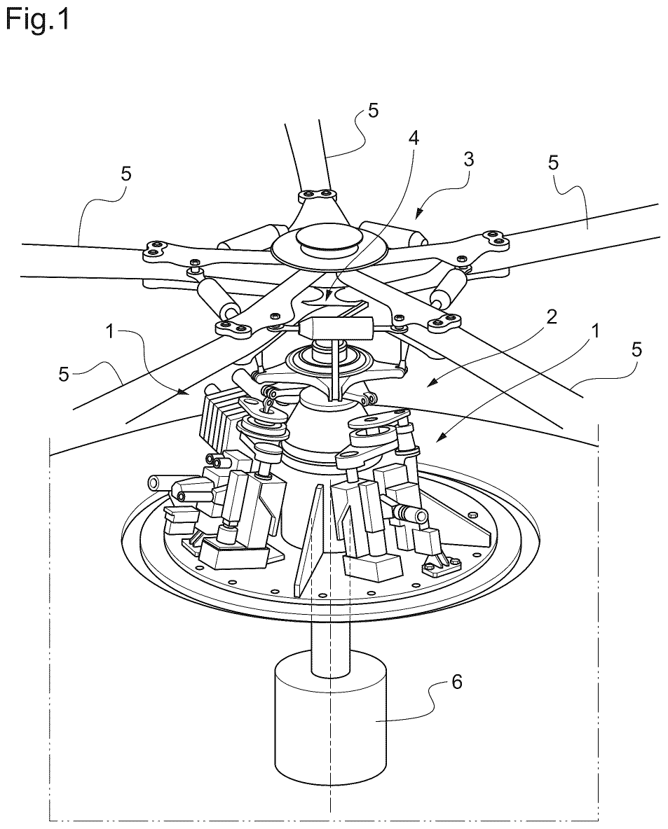

As shown in FIG. 1, the disclosure relates, for example, to the field of test benches 2 for testing rotors 3 of an aircraft, such as rotorcraft rotors. Such a rotor 3 to be tested is thus equipped with a hub 4 and variable-pitch blades 5 carried by the hub 4. In addition, a conventional plate system can make it possible to vary the pitch of the blades of the rotor cyclically and collectively, being connected to the blades by connecting rods.

In addition, such a test bench 2 comprises a motor 6 for rotating the rotor 3 in order to simulate normal operation on an aircraft.

Moreover, in order to modify the pitch of the blades 5 of the rotor 3, the test bench 2 comprises at least one linear actuating device 1 connected firstly to the system of plates and secondly to a chassis of the test bench. During a rotational movement of the rotor 3, the one or more linear actuating devices 1 are able, in a nominal operating mode, to vary the pitch of the blades 5 of the rotor 3 with respect to the hub 4 and, in an emergency operating mode, to maintain the pitch of the blades 5 of the rotor 3 towards a predetermined value.

Such a test bench 2 can thus comprise linear actuating devices 1 replacing the respective servo-controls equipping an aircraft when the rotor 3 is used in normal conditions on the aircraft.

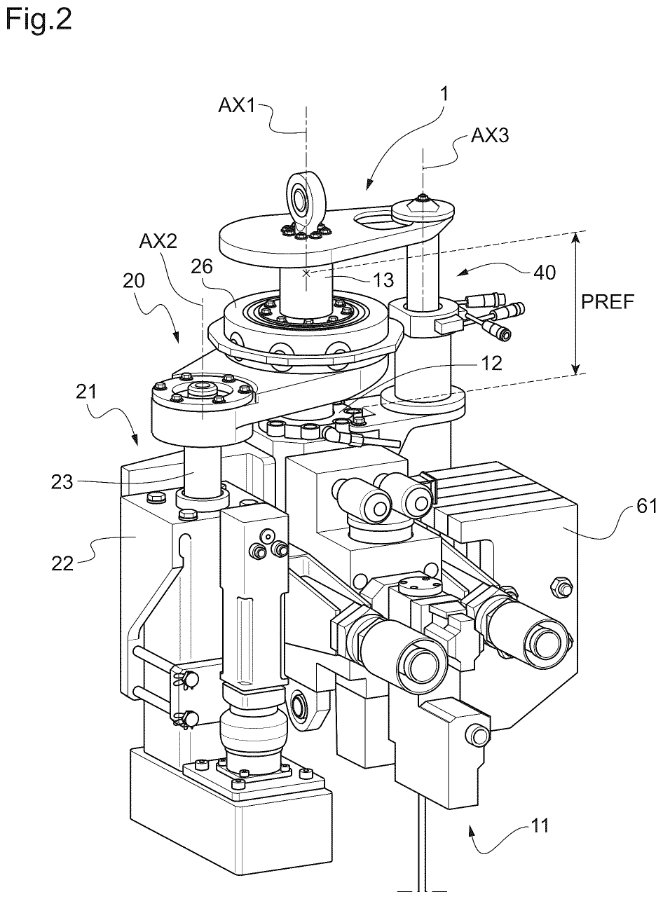

Such a linear actuation device 1 is shown in more detail in FIG. 2, and is able to simulate the operation and stresses of a rotor 3 on the ground.

This linear actuating device 1 comprises, in particular, a main actuator 11 provided with a main body 12 and a main rod 13 able to move with one degree of freedom in translation with respect to the main body 12. Thus, the main rod 13 can be moved with respect to the main body 12 along a main translation axis AX1. For example, if the main actuator 11 is a hydraulic cylinder, the main rod 13 is secured to a piston arranged in the main body 12. The piston is then moved with the main rod 13 by means of a pressurized fluid transmitted into a chamber by a main hydraulic supply. Alternatively, such a main actuator 11 may be an electric or pneumatic cylinder.

According to a characterizing feature of the disclosure, this linear actuating device 1 comprises an emergency system 20 that is able, in a nominal operating mode of the linear actuating device 1, to allow a movement of the main rod 13 with respect to the main body 12.

On the other hand, in an emergency operating mode of the linear actuating device 1, the emergency system 20 is able to immobilize the main rod 13 of the main actuator 11 in a predetermined refuge position PREF.

This emergency system 20 may comprise a secondary actuator 21 provided with a secondary body 22 that may, for example, be secured to the main body 12 and with a secondary rod 23 that is able to move with one degree of freedom in translation with respect to the secondary body 22.

Thus, the secondary rod 23 can be moved with respect to the secondary body 22 along a secondary translation axis AX2, for example by means of an electric motor, if the secondary actuator 21 is an electric cylinder. Alternatively, the secondary actuator 21 may be a hydraulic or pneumatic cylinder.

In addition, the secondary rod 23 is secured to the main rod 13 only in the emergency operating mode of the linear actuating device 1.

For this purpose, the emergency system 20 may comprise a hydraulic blocker 26 secured to the secondary rod 23.

Furthermore, the emergency system 20 may also comprise a tracking system 40 configured to generate tracking information as a function of a current position of the main rod 13 with respect to the main body 12 relative to the refuge position PREF.

Finally, such a linear actuating device 1 may comprise at least one balancing counterweight 61 offset radially with respect to the main translation axis AX1.

Such a balancing counterweight 61 is thus able to counteract the imbalance generated by the use of the secondary actuator 21, that is also offset radially with respect to the main translation axis AX1.

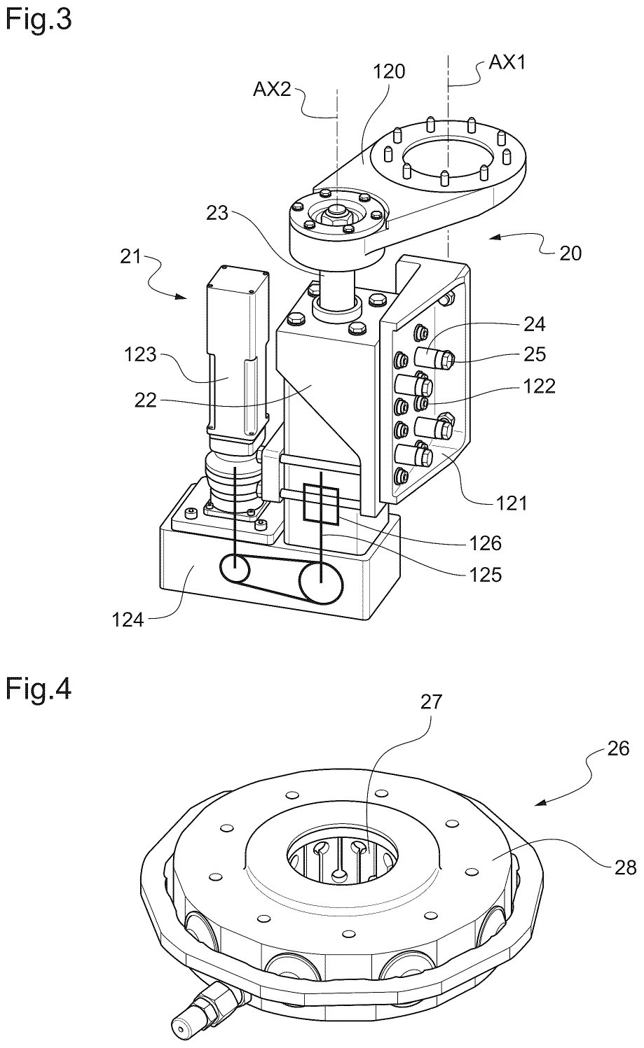

As shown in FIG. 3, the emergency system 20 may include adjustment means 24 configured to axially adjust a relative position between the secondary body 22 and the main body 12, as well as reversible securing means 25 configured to secure the secondary body 22 to the main body 12.

The adjustment means 24 may comprise holes 122 of oblong shape and/or a plurality of holes 122 spaced apart by the same center-to-center distance and able to adjust different fixing positions between the secondary body 22 and the main body 12. In addition, as shown, the holes 122 may be arranged on a bracket 121 secured to the main body 12.

The reversible securing means 25 may be formed by complementary screws or studs and nuts.

In addition, the emergency system 20 may include a first connecting arm 120 secured firstly to the secondary rod 12 and secondly to the hydraulic blocker 26 by conventional screwing, welding or other means. Such a first connecting arm 120 is then able to secure the main rod 13 and the secondary rod 23 by means of the hydraulic blocker 26 in the emergency operating mode of the linear actuating device 1. Such a first connecting arm 120 can, for example, extend substantially perpendicularly with respect to the main translation axis AX1 and to the secondary translation axis AX2.

Such a secondary actuator 21 may comprise an electric motor 123 and a belt-type angle transmission system 124 able to rotate an endless screw 125 and to generate the translational movement of the secondary rod 23 by means of a nut secured to the secondary rod 23 or a ball mechanism 126 capable of converting the rotational movement of the endless screw 125 into a translational movement of the secondary rod 23.

As shown in more detail in FIGS. 4 to 8, the hydraulic blocker 26 comprises a deformable clamping ring 27 configured, in the nominal operating mode, to allow the frictionless sliding of the main rod 13 therein. In the emergency operating mode, the deformable clamping ring 27 is configured to exert a pressing force on the main rod 13 in order to secure together the main rod 13 and the secondary rod 23 in translation.

In addition, according to FIG. 4, the hydraulic blocker 26 also comprises a housing 28 inside which the clamping ring 27 is arranged. In addition, such a housing 28 has an internal volume able both to contain the clamping ring 27 and to provide the clamping ring 27 with a capacity for radial deformation around the main rod 13.

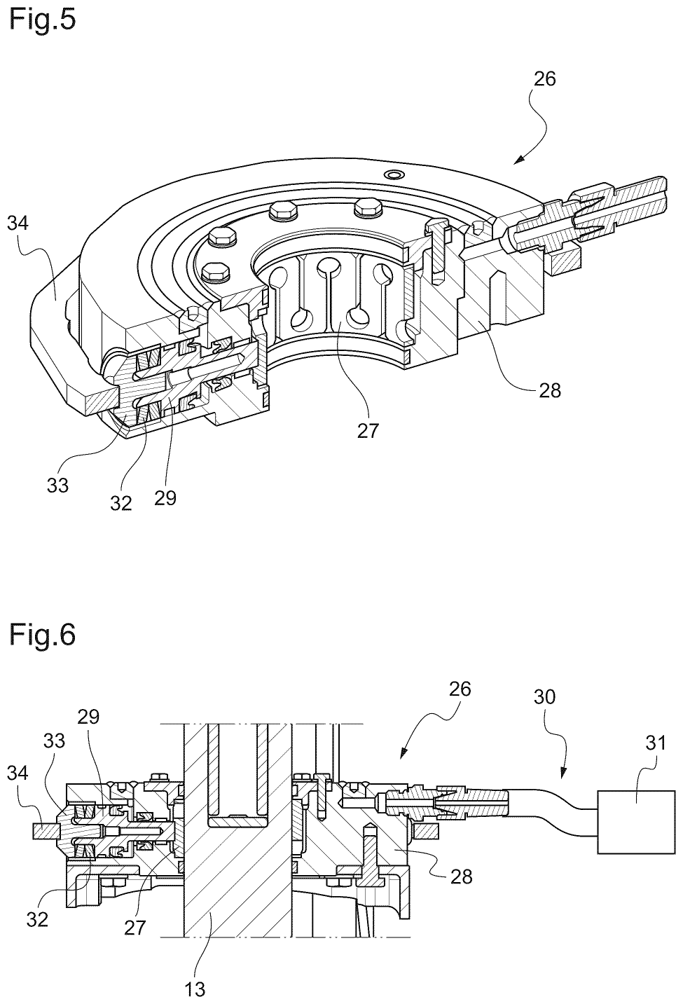

As shown in FIGS. 5 to 8, the hydraulic blocker 26 also comprises a plurality of pistons 29 arranged in the housing 28 and able to move radially with respect to the main translation axis AX1.

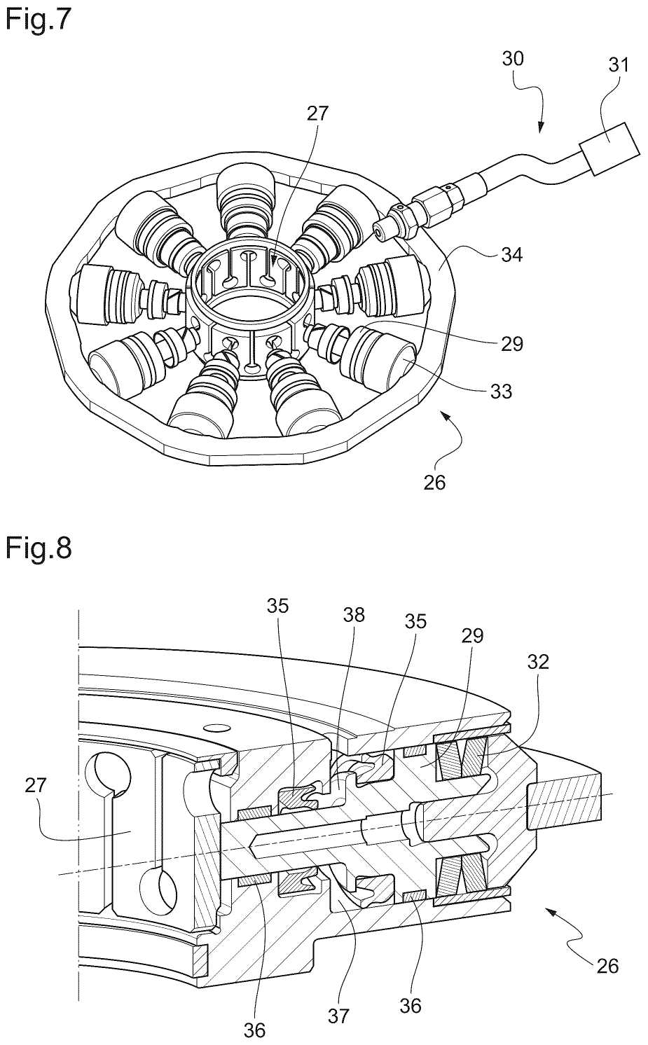

As shown in FIGS. 6 and 7, such pistons 29 can slide respectively in chambers 37 hydraulically connected in parallel to a hydraulic supply 30 comprising a pump 31. Such a pump 31 is then configured to compress a fluid in the chambers 37 in the nominal operating mode of the linear actuating device 1.

Such a pressurized fluid is then able to exert a thrust force on each piston 29 in order to place each piston 29 in a first end position during the nominal operating mode.

Furthermore, the hydraulic blocker 26 also comprises elastic return means 32, such as deformable conical washers, jointly exerting a return force on a piston 29 in order to move each piston 29 from the first end position to a second end position when the fluid is no longer under pressure in each chamber 37 during the emergency operating mode. The pistons 29 then exert forces on the clamping ring 27. The pistons 29 deform the clamping ring 27 that then clamps the main rod.

Advantageously, such a hydraulic blocker 26 may comprise a plurality of stops 33 and an elastic ring 34 that is able to increase the return force generated by the elastic return means 32 on each piston 29.

Each stop 33 cooperates in a sliding pivot connection with a piston 29 so as to center the stop 33 with respect to the piston 29 and make it possible to confer at least one degree of freedom in translation on a stop 33 with respect to a piston 29. Each stop 33 cooperates according to a planar support type connection with an elastic return means 32 to serve as an axial stop and oppose the thrust force exerted by the piston 29 urged into the first end position by the pressurized fluid.

As shown in FIG. 7, the hydraulic blocker 26 may comprise nine pistons 29 and nine stops 33 arranged radially between the clamping ring 27 and the elastic ring 34.

As shown in FIG. 8, the hydraulic blocker 26 may include seals 35 for sealingly containing the hydraulic fluid supplied by the hydraulic supply system 30 in each of the chambers 37 defined by the housing 28 and the piston 29. The hydraulic fluid can then exert a thrust force on a planar face 38 of the piston 29.

In addition, the hydraulic blocker 26 may also comprise guide rings 36 for guiding each piston 29 in translation in the housing 28.

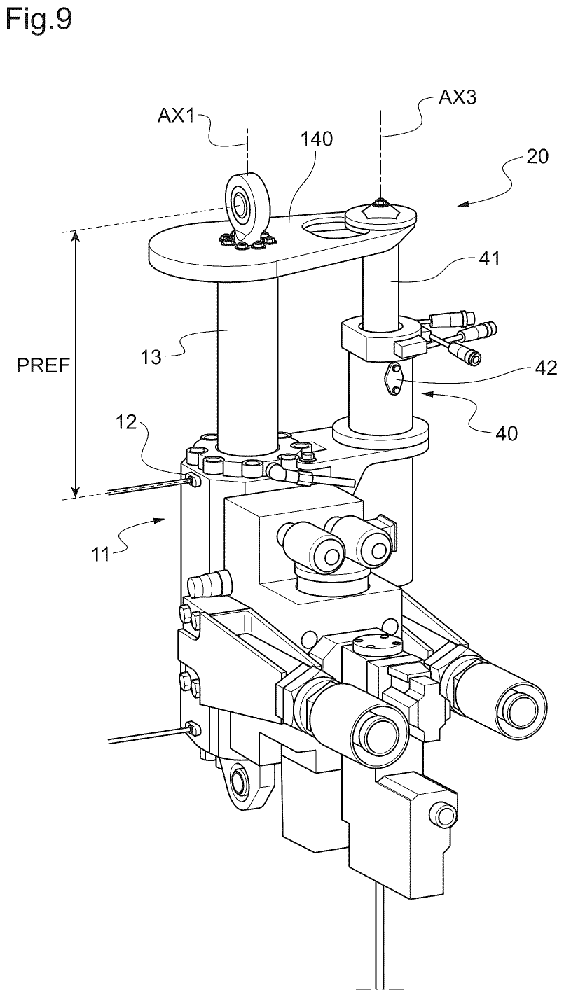

As shown in FIG. 9, the tracking system 40 may include a sheath 41 that is able to move with one degree of freedom in translation with respect to a support 42 along a tracking translation axis AX3. Such a sheath 41 is secured to the main rod 13 by means of a second connecting arm 140 fixed in interlocking connection to respective free ends of the main rod 13 and the sheath 41. Such a second connecting arm 140 may extend perpendicularly to the main translation axis AX1 and to the tracking translation axis AX3.

Such a sheath 41 can thus move in translation together with the main rod 13, the tracking translation axis AX3 being parallel to the main translation axis AX1.

Furthermore, the support 42 may be secured to the main body 12 of the main actuator 11.

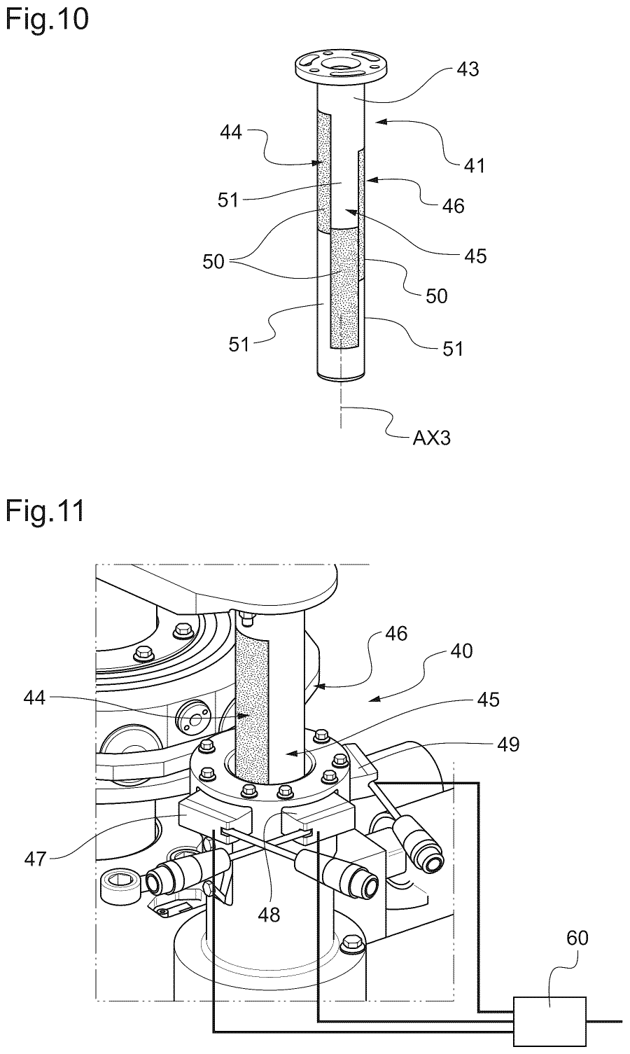

As shown in FIG. 10, the sheath 41 may comprise an outer cylindrical surface 43 provided with three tracks 44, 45, 46 oriented in parallel along the tracking translation axis AX3. These three tracks 44, 45, 46 may be arranged against each other or be respectively offset in azimuth with respect to each other, around the tracking translation axis AX3.

Each of the three tracks 44, 45, 46 may have at least two colored portions 50, 51 intended to cooperate with three sensors 47, 48, 49 of the tracking system 40.

As shown in FIG. 11, the three sensors 47, 48, 49 are secured to the support 42 and are able to identify which colored portion 50, 51 is arranged facing the sensors 47, 48, 49, in order to know the relative position of the main rod 13 with respect to its refuge position PREF. In practice, each sensor 47, 48, 49 can provide a binary digital signal such as 0 when a first colored portion 50 is arranged opposite, and alternatively 1 when a second colored portion 51 is arranged opposite.

Thus, each track 44, 45, 46 is arranged opposite a sensor 47, 48, 49 and includes at least two colored portions 50, 51 having at least two different colors intended to be identified by the sensor 47, 48, 49.

Each sensor 47, 48, 49 is thus able to detect a colored portion 50, 51, and the sensors together make it possible to determine the current relative position of the sheath 41 with respect to the refuge position PREF by using a truth table in Boolean algebra. For example, the refuge position may be defined by the simultaneous identification on the three tracks 44, 45, 46 of a combination of three colored portions 50 having a first identical color. According to the truth table, each colored portion 50 is then assigned to the value 0 and each colored portion 51 is assigned to the value 1.

A first track 44 may thus have two colored portions 50, 51 of different colors arranged one after the other in a direction parallel to the tracking translation axis AX3. For example, a first colored portion 50 arranged in an upper portion of the sheath 41 has the first color, and a second colored portion 51 arranged in a lower portion of the sheath 41 has a second color.

This first track 44 can indicate a first movement direction of the main rod 13 with respect to its refuge position PREF. According to the example described above, this first movement direction may thus correspond to an axis oriented from the lower part of the sheath 41 towards the upper part of the sheath 41.

A second track 45 may have two colored portions 50, 51 of different colors arranged one after the other in a direction parallel to the tracking translation axis AX3, the arrangement of the two colored portions 50, 51 of the second track 45 being reversed with respect to that of the first track 44. For example, a first colored portion 50 arranged in the lower part of the sheath 41 has the first color, and a second colored portion 51 arranged in the upper part of the sheath 41 has the second color. The refuge position PREF can then be identified at a very localized azimuth overlap of the first colored portions 50 of the first and second tracks 44, 45.

This second track 45 may indicate a second movement direction, opposite to the first movement direction, of the main rod 13 with respect to its refuge position PREF. This second movement direction can thus correspond to an axis oriented from the upper part of the sheath 41 towards the lower part of the sheath 41.

Finally, a third track 46 may have three colored portions 50, 51 with two different colors arranged one after the other in a direction parallel to the tracking translation axis AX3.

For example, a first colored portion 50 arranged in a central portion of the sheath 41 has the first color, a second colored portion 51, arranged in the upper portion of the sheath 41, has the second color, and a third colored portion 51, arranged in the lower portion of the sheath 41, also has the second color.

In addition, the main rod 13 may be arranged in its refuge position PREF when simultaneously a first sensor 47 detects the first color on the first track 44, a second sensor 48 detects the first color on the second track 45, and a third sensor 49 detects the first color on the third track 46.

The second and third colored portions 51, when detected by the third sensor 49, then make it possible to identify that an end-of-travel stop of the main rod 13 has been reached.

In conjunction with detection of the second colored portions 51 of the first and second tracks 44, 45 the truth table identifies whether it is an upper or a lower end-of-travel stop. Indeed, when the second colored portion 51 of the first track 44 is simultaneously detected with the second colored portion 51 of the third track 46, an upper stop can be identified and when the second colored portion 51 of the second track 45 is simultaneously detected with the third colored portion 51 of the third track 46, a lower end-of-travel stop of the main rod 13 can be identified.

In addition, the tracking system 40 may include a controller 60 connected to the three sensors 47, 48, 49 in order to generate the tracking information as a function of the current position of the main rod 13 with respect to the refuge position PREF.

Depending on the tracking information, the controller 60 may control the secondary actuator 21 to move and maintain the main rod 13 in the refuge position PREF.

The controller 60 can use the Boolean algebra truth table stored in a memory. For example, the refuge position PREF may be defined by a combination of three first colored portions 50 with a first identical color corresponding to a central zone of the sheath 41.

A first movement direction of the main rod 13 can be controlled when a second colored portion 51 having a second color is detected on the first track 44 by the first sensor 47.

A second movement direction of the main rod 13 can be controlled when a second colored portion 51 having a second color is detected on the second track 45 by the second sensor 48.

An upper stop of the main rod 13 can be identified when both a second colored portion 51 having a second color is detected on the first track 44 by the first sensor 47 and a second colored portion 51 having a second color is detected on the third track 46 by the third sensor 49.

Finally, a lower stop of the main rod 13 can be identified when both a second colored portion 51 having a second color is detected on the second track 45 by the second sensor 48, and a second colored portion 51 having a second color is detected on the third track 46 by the third sensor 49.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A linear actuating device comprising a main actuator provided with a main body and with a main rod able to move with at least one degree of freedom in translation with respect to the main body,
the linear actuation device comprising an emergency system configured to:
in a nominal operating mode of the linear actuating device, allow a movement of the main rod of the main actuator with respect to the main body; and
in an emergency operating mode of the linear actuating device, return and then maintain the main rod of the main actuator in a predetermined refuge position,
the emergency system comprising a secondary actuator provided with a secondary body and with a secondary rod able to move with one degree of freedom in translation with respect to the secondary body, the secondary rod being secured to the main rod, only in the emergency operating mode of the linear actuating device,
wherein the emergency system comprises a hydraulic blocker secured to the secondary rod, the hydraulic blocker comprising a deformable clamping ring configured to:
in the nominal mode of operation, enable frictionless sliding of the main rod with respect to the clamping ring; and
in the emergency operating mode, exert a pressing force on the main rod and secure together the main rod and the secondary rod in translation.

2. The device according to claim 1,
wherein the emergency system comprises adjustment means configured to axially adjust a relative position between the secondary body and the main body as well as reversible securing means configured to secure the secondary body to the main body.

3. The device according to claim 1,
wherein the hydraulic blocker comprises:
a housing;
a plurality of pistons radially arranged in the housing with respect to a main translation axis of movement of the main rod, the pistons sliding respectively in chambers hydraulically connected in parallel to a hydraulic supply comprising a pump configured to compress a fluid in the chambers, the fluid enabling a thrust force to be exerted on each piston in order to place each piston in a first end position corresponding to the nominal operating mode; and
elastic return means each exerting a return force on a piston in order to move each piston from the first end position to a second end position corresponding to the emergency operating mode.

4. The device according to claim 1,
wherein the emergency system comprises a tracking system configured to generate tracking information as a function of a current position of the main rod with respect to the main body relative to the refuge position.

5. The device according to claim 4,
wherein the tracking system comprises a sleeve that can move with one degree of freedom in translation with respect to a support along a tracking translation axis, the sleeve being secured with the main rod and configured to move in translation jointly with the main rod, the tracking translation axis being parallel to the main translation axis.

6. The device according to claim 5,
wherein the sleeve comprises an outer cylindrical surface provided with three tracks oriented parallel with the tracking translation axis, the three tracks being respectively offset in azimuth with respect to each other around the tracking translation axis.

7. The device according to claim 6,
wherein the tracking system comprises three sensors secured to the support, each track being arranged opposite a sensor and having at least two colored portions having at least two different colors intended to be identified by the sensor.

8. The device according to claim 7,
wherein, the emergency system comprising a secondary actuator provided with a secondary body and with a secondary rod able to move with one degree of freedom in translation with respect to the secondary body, the tracking system comprises a controller connected to the three sensors in order to generate the tracking information as a function of the current relative position of the main rod with respect to the refuge position, and to control the secondary actuator in order to move the main rod into the refuge position.

9. The device according to claim 1,
wherein the linear actuating device comprises at least one balancing counterweight offset radially with respect to a main translation axis of movement of the main rod.

10. An aircraft rotor test bench, the rotor being provided with a hub and blades, the test bench comprising a motor for rotating the rotor,
wherein the test bench comprises at least one linear actuating device and wherein, during a rotational movement of the rotor, the at least one linear actuating device is configured, in the nominal operating mode, to vary a pitch of the blades of the rotor with respect to the hub and, in the emergency operating mode, to maintain the pitch of the blades of the rotor towards a predetermined value.
